(19) United States
(12) Patent Application Publication
(10) Pub. No.: US 2003/0202521 A1
(43) Pub. Date: Oct. 30, 2003

(54) SYSTEM AND METHOD FOR NEGOTIATION OF MULTI-MEDIA CAPABILITIES ACROSS NETWORKS

(76) Inventors: THEODORE HAVINIS, RICHARDSON, TX (US); HEINO HAMELEERS, KERKRADE (NL); GEORGE VERGOPOULOS, HERZOGENRATH (DE)

Correspondence Address: THOMAS L CRISMAN, JENKENS & GILCHRIST PC, 3200 FOUNTAIN PLACE, 1445 ROSS AVENUE, DALLAS, TX, 752022799

(21) Appl. No.: 09/394,111

(22) Filed: Sep. 10, 1999

(51) Int. Cl. H04L 12/56

(52) U.S. Cl. 370/401

(57) ABSTRACT

A telecommunications system and method is disclosed for converting between networks for multi-media purposes by adding an attribute to the call control protocol to indicate the multi-media coding of the calling subscriber. This attribute is used to negotiate the multi-media coding between the different nodes involved in a call. Based on the negotiation, various Media Gateways (MG) can be selected to perform the necessary interworking.

### BACKGROUND OF THE PRESENT INVENTION

1. Field of the Invention

The present invention relates generally to telecommunications systems and methods for implementing multi-media capabilities within a telecommunications network, and specifically to multi-media interworking between telecommunications networks.

2. Background of the Present Invention

Different multi-media standards have been defined for different types of public networks. For example, for Integrated Services Digital Networks (ISDN), the H.320 and H.324I/M standards are utilized. By contrast, for Local Area Networks (LANs), the H.323 standards are used. In addition, H.324 standards apply to Public Switched Telephony Networks (PSTNs), whereas H.324M standards apply to Public Land Mobile Networks (PLMNs).

When multi-media streams traverse borders of different networks, user plane interworking between these different standards may have to be performed. As an example, for a call originating from an ISDN H.320 terminal to an H.323 in a LAN, a Media Gateway (MG) is needed to interwork between H.320 and H.323 multi-media.

Currently, if a call originates from an H.323 terminal, the dialed B-number can be used to indicate the type of network associated with the called subscriber. In this case, a dependency between the dialed B-number and the different number series associated with the called subscriber is stored within the H.323 network. Thus, based on the B-number, the H.323 network can determine which MG to use to convert between the H.323 network and the called subscriber's network. For example, a call from an H.323 terminal to a mobile H.324M terminal can be routed, using the dialed B-number, to a specific MG to perform a H.323 to H.324M conversion.

However, this approach requires that different number series be used for different types of networks (e.g., ISDN and PSTN), which in the case of fixed networks, is not a recommended approach. This may also require additional standardization. Furthermore, this approach would require a high level of (numbering plan) knowledge in the switches that route between the different network types. In addition, the possibility of multiple interworking during call forwarding traffic cases might lead to degradation of perceived quality.

Another option currently being considered is to add a prefix to the called B-number to indicate that a conversion to another format is needed. However, this would require the originating subscriber to know the capabilities of the called subscriber's terminal. Furthermore, without standardization, a prefix would only work in the home network. For example, in case of a Mobile Station (MS) roaming to another network, the prefix would not be able to be used anymore. In addition, forcing the subscriber to add a prefix to the called B-number is not only inconvenient, but also increases the complexity in cases where other prefixes have to be used (e.g., for IN or carrier selection).

### SUMMARY OF THE INVENTION

The present invention is directed to telecommunications systems and methods for converting between networks for multi-media purposes by adding an attribute to the call control protocol to indicate the multi-media coding of the calling subscriber. This attribute is used to negotiate the multi-media coding between the different nodes involved in a call. Based on the negotiation, various Media Gateways (MG) can be selected to perform the necessary interworking. Advantageously, this mechanism can be applied to most known call control protocols, such as H.323 (H.225) and Integrated Services Digital Network User Part (ISUP) In addition, this mechanism can also be applied to cases in which the call is rerouted to a node with different multi-media capabilities than the originally addressed node.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a block diagram illustrating a sample negotiation of multi-media capabilities between a calling subscriber network and a called subscriber network in accordance with embodiments of the present invention;

FIG. 2 is a signaling diagram illustrating the various signaling involved in the negotiation process shown in FIG. 1 of the drawings;

FIG. 3 is a block diagram illustrating a sample negotiation of multi-media capabilities when a called subscriber has been forwarded to another network;

FIG. 4 is a signaling diagram illustrating the signaling involved in the negotiation process shown in FIG. 3 of the drawings; and

FIG. 5 is a block diagram illustrating a sample interworking between two networks using multiple Media Gateways (MG) in accordance with embodiments of the present invention.

### DETAILED DESCRIPTION OF THE PRESENTLY PREFERRED EXEMPLARY EMBODIMENTS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

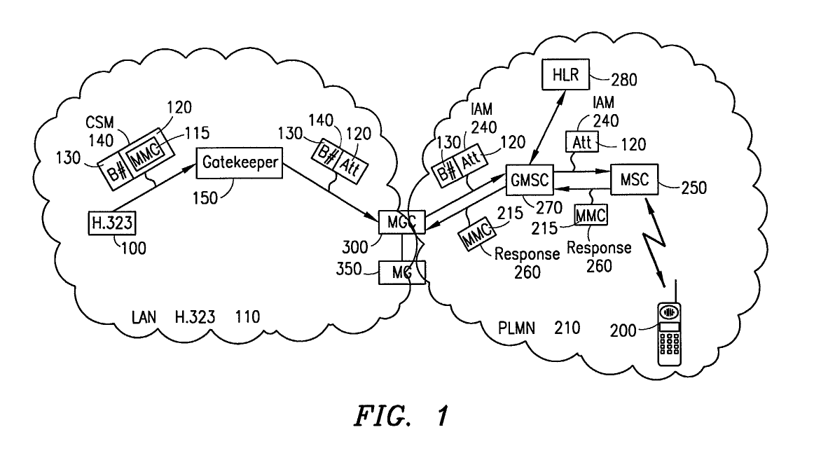

With reference now to FIG. 1 of the drawings, an example of a negotiation of multi-media capabilities across networks is shown. In FIG. 1, a calling subscriber 100 is within a Local Area Network (LAN) 110 utilizing H.323 protocols 115, while a called subscriber 200 is within a Public Land Mobile Network (PLMN) 210 utilizing H.324M protocols 215. To interwork between the H.323 protocols 115 and the H.324M protocols 215, an appropriate Media Gateway (MG) 350 must be chosen. However, since neither the calling subscriber 100 nor the calling subscriber's network 110 usually have knowledge of the called subscriber's 200 multi-media capabilities 215, to foster multi-media interworking, an attribute 120 can be added to the call control protocol to indicate the calling subscriber's multi-media coding 115. This attribute 120 can be used to negotiate the multi-media coding between the different nodes involved in a call. Based on the negotiation, appropriate MG's 350 can be selected which perform the necessary interworking.

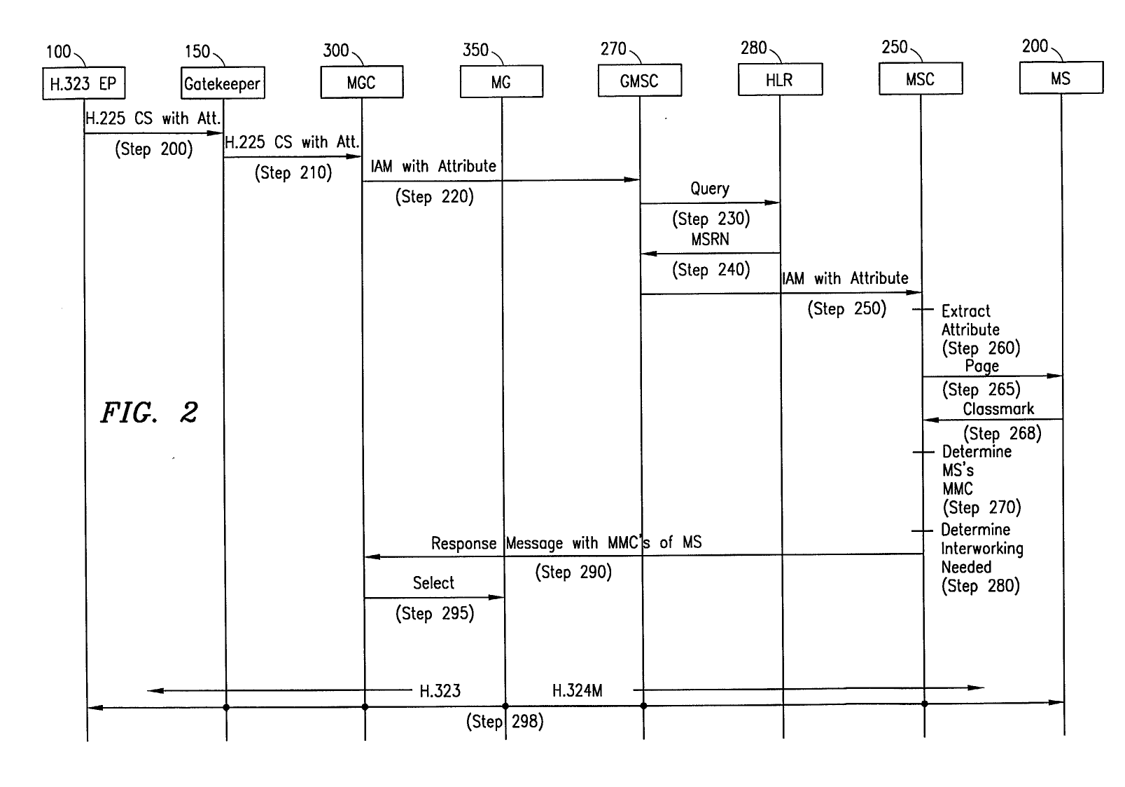

For example, with reference now to the signaling diagram shown in FIG. 2 of the drawings, which will be described in connection with FIG. 1 of the drawings, when an H.323 endpoint 100 (calling subscriber) within an H.323 network 110 initiates a call to a Mobile Station (MS) 200 (called subscriber) within a PLMN 210, such as a Global System for Mobile Communications (GSM) network, the H.323 endpoint 100 sends a call setup message 140, including a B-number 130 for the called MS 200 and the attribute 120, to a Gatekeeper 150 within the H.323 network 110 (step 200). Alternatively, the Gatekeeper 150 can add the attribute 120 to the call setup message 140. It should be understood that the Gatekeeper 150 is responsible for providing call control services to the H.323 endpoints 100 within the H.323 network 110. In addition, within the H.323 network 110, the call setup message 140 is sent using the H.225 protocol, which is the transmission format utilized in H.323 networks 110.

When the Gatekeeper 150 receives the H.225 call setup message 140, including the attribute 120 and B-number 130, the Gatekeeper 150 realizes that the call is to a called subscriber 200 outside of the H.323 network 110, and routes the H.225 call setup message 140 to a Media Gateway Controller (MGC) 300 (step 210), which provides for the necessary conversion of signaling between the H.323 network 110 and the destination network, which in this case is the PLMN 210. In response, the MGC 300 converts the H.225 call setup message 140 to an Initial Address Message (IAM) 240, which is used in the PLMN 210 to establish a call connection. The MGC 300 also includes the B-number 130 and the attribute 120 in the IAM 240.

Once converted, the MGC 300 routes the IAM 240, including the B-number 130 and attribute 120, to a Gateway Mobile Switching Center (GMSC) 270 in the PLMN 210 (step 220). The GMSC 270, in turn, uses the B-number 130 to query a Home Location Register (HLR) 280 associated with the called MS 200 (step 230). The HLR 280 stores subscriber information for the called MS 200, along with location information associated with a current Mobile Switching Center (MSC) 250 serving the called MS 200. In response to the query, the HLR 280 returns a Mobile Station Roaming Number (MSRN) to the GMSC 270 (step 240), which uses this MSRN to route the IAM 240, including the attribute 120, to the serving MSC 250 (step 250). Upon receiving the IAM 240, the MSC 250 extracts the attribute 120 (step 260), determines the multi-media capabilities 215 of the called MS 200 (step 270), and makes a determination as to whether interworking between the multi-media capabilities 115 of the calling subscriber 100 and the multi-media capabilities 215 of the called subscriber 200 is needed (step 280). It should be noted that the MSC 250 can determine the multi-media capabilities of the called MS 20 based on subscriber information downloaded to the MSC 250 from the HLR 280 or based on information provided to the MSC 250 from the MS 20 in a CLASSMARK message (step 268) in response to the MSC 250 paging the MS 20 (step 265), the latter being illustrated.

In this case, since the calling subscriber is an H.323 endpoint 100 within the H.323 network 110, and the called subscriber is an MS 200 within the PLMN 210, the MSC 250 would typically determine that interworking is needed, and send a new response message 260 to the MGC 300 via the GMSC 270 indicating that interworking between H.323 115 and H.324M 215 is needed for this call (step 290). The response message 260 is sent prior to the existing call proceeding message. However, it should be noted that in some cases, the MSC 250 may have the necessary gateway functionality to provide interworking between H.323 115 and H.324M 215 multi-media protocols.

In response, the MGC 300 selects an appropriate MG 350 to perform the conversion of the media streams between the packet switched H.323 network 110 and the circuit-switched H.324M network 210 (step 295). It should be noted that the selected MG 350 may be within the same node as the MGC 300. Thereafter, a call connection is established between the calling H.323 endpoint 100 and the called MS 200, and speech and data are converted at the selected MG 350 (step 298).

It should be noted that the above-described mechanism can be applied to any known call control protocols. In addition, the above-described mechanism can also work in cases where the call is re-routed to a node with different multi-media capabilities than the originally addressed node.

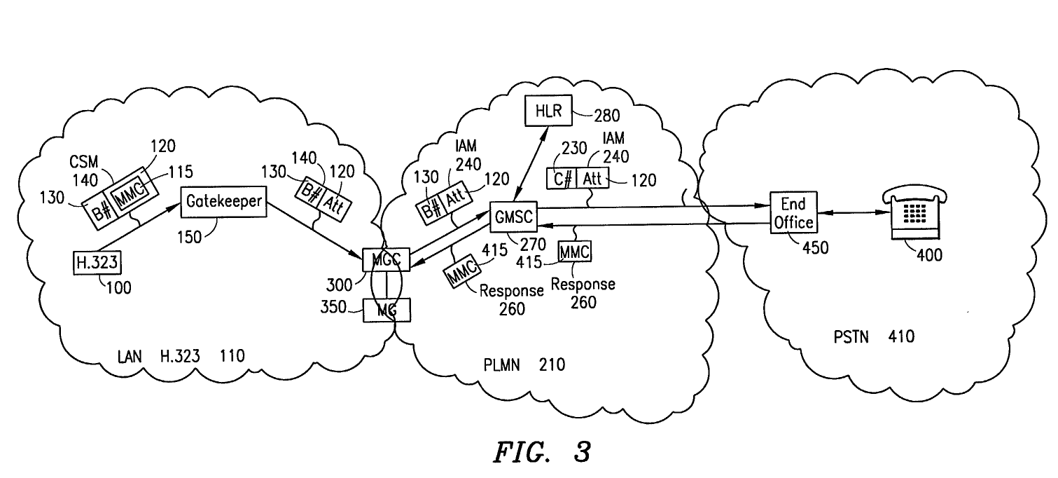

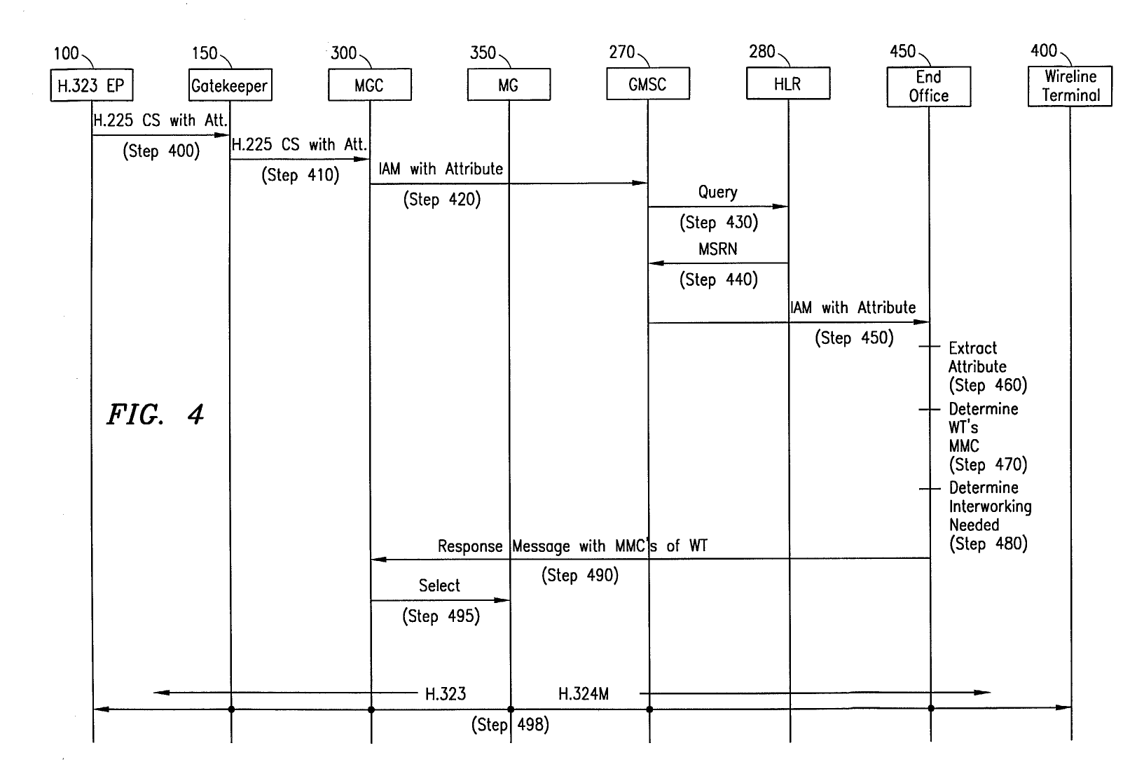

For example, with reference now to FIG. 3 of the drawings, which will be described in connection with the signaling diagram shown in FIG. 4 of the drawings, the called subscriber has forwarded calls to the called MS 200 to a wireline terminal 400 within the Public Switched Telephone Network (PSTN) 410. As described above, when the H.323 endpoint 100 sends the H.225 call setup message 140 including the B-number 130 and attribute 120 to the Gatekeeper 150 (step 400), the Gatekeeper 150 routes the H.225 call setup message 140 to the MGC 300 (step 410). The MGC 300, in turn, routes the IAM 240, including the attribute 120 and B-number 130, to the GMSC 270 within the PLMN 210 (step 420), which queries the HLR 280 for routing information for the called subscriber (step 430). If the called subscriber has activated a call forwarding service to a C-number 230, the HLR 280 returns the C-number 230 to the GMSC 270 (step 440). It should be understood that if the called subscriber has activated a call forwarding on busy service, the MSC 250 (shown in FIG. 1) would return the forwarded-to C-number 230 to the GMSC 270.

Upon receiving the C-number 230, the GMSC 270 routes the IAM 240, including the attribute 120 and the C-number 230, to an end office 450 within the PSTN 410 serving the wireline terminal 400 associated with the C-number 230 (step 450). At this point, the end office 450 extracts the attribute 120 (step 460), determines multi-media capabilities 415 of the called wireline terminal 400 (step 470), and makes a determination as to whether interworking between the multi-media capabilities 115 of the calling subscriber 100 and the multi-media capabilities 215 of the called subscriber 415 is needed (step 480).

In this case, since the calling subscriber is an H.323 endpoint 100 within the H.323 network 110, and the called subscriber is a wireline terminal 400 within the PSTN 415, the end office 450 would typically determine that interworking is needed, and send the response message 260 to the MGC 300 via the GMSC 270 indicating that interworking between H.323 115 and H.324 415 is needed for this call (step 490). In response, the MGC 300 selects an appropriate MG 350 to perform the conversion of the media streams between the packet switched H.323 network 110 and the circuit-switched H.324 network 410 (step 495). Thereafter, a call connection is established between the calling H.323 endpoint 100 and the called wireline terminal 400, and speech and data are converted at the selected MG 350 (step 498).

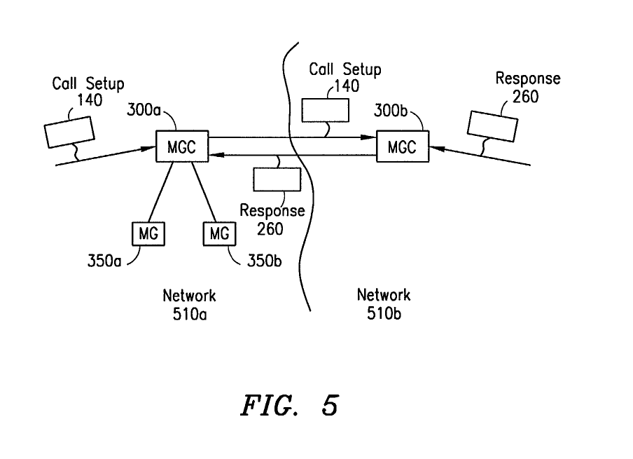

In alternative embodiments, there can be a number of MGC's 300 within the call setup chain, instead of the one MGC 300 shown in FIGS. 1 and 3. For example, with reference now to FIG. 5 of the drawings, the call setup message 140 may have to be routed through several intermediate networks, only two of which are shown 510a and 510b, each having at least one associated MGC 300a and 300b, respectively. In addition, there can be a number of MG's, only two of which are shown 350a and 350b, for each MGC 300a. Each MG 350a and 350b, for example, can be responsible for interworking between two different respective types of networks.

Thus, when the response message 260 arrives at the last MGC 300b in the chain, which is the MGC 300b closest to the called subscriber, that MGC 300b can either select a MG (not shown) associated with that MGC 300b to perform the conversion, or send the response message 260 to a previous MGC 300a to select a MG, for example MG 350b, to perform the conversion. This may occur if, for example, the last MGC 300b does not have a MG that is able to perform the conversion. It should be understood that, in this case, the last MGC 300b can either send the response message 260 to a previous MGC 300a or to another MGC (not shown) that has a MG (not shown) capable of performing the required conversion.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

What is claimed is:

1. A telecommunications system for negotiating multi-media capabilities for a call, comprising:
a media gateway for converting between first and second multi-media capabilities associated with said call; and
a media gateway controller for receiving a call setup message for said call, said call setup message including an attribute indicating said first multi-media capability, said media gateway controller further for receiving a response message including at least said second multi-media capability and selecting said media gateway based on said received first and second multi-media capabilities.

2. The telecommunications system of claim 1, wherein said first multi-media capability is associated with a calling terminal and said second multi-media capability is associated with a called terminal.

3. The telecommunications system of claim 2, wherein said calling terminal is within a first network, and said called terminal is within a second network.

4. The telecommunications system of claim 3, wherein said first and second networks utilize different call control protocols.

5. The telecommunications system of claim 4, further comprising:
a second node within said second network and serving said called terminal, said second node receiving said call setup message including said attribute from said media gateway controller, determining said second multi-media capability associated with said called terminal and sending said response message to said media gateway controller in response to a determination that interworking between said first and second multi-media capabilities is needed and that said second node cannot perform said interworking.

6. The telecommunications system of claim 5, further comprising:
a first node within said first network and serving said calling terminal, said first node for sending said call setup message including said attribute to said media gateway controller.

7. The telecommunications system of claim 6, wherein said first node receives said call setup message including said attribute from said calling terminal.

8. The telecommunications system of claim 6, wherein said first node receives said call setup message from said calling terminal and adds said attribute to said call setup message.

9. The telecommunications system of claim 6, wherein said call setup message further includes a B-number associated with a third network.

10. The telecommunications system of claim 9, further comprising:
a third node within said third network for receiving said call setup message including said attribute and said B-number from said media gateway controller, determining a C-number associated with said called terminal and forwarding said call setup message including said attribute to said second node.

11. A method for negotiating multi-media capabilities for a call, comprising the steps of:
receiving a call setup message for said call at a media gateway controller, said call setup message including an attribute indicating a first multi-media capability for said call;
receiving a response message including at least a second multi-media capability for said call at said media gateway controller; and
selecting a media gateway for converting between said first and second multi-media capabilities associated with said call based on said received first and second multi-media capabilities.

12. The method of claim 11, wherein said step of receiving said call setup message further comprises the step of:
sending said call setup message including said attribute from a first node serving a calling terminal within a first network to said media gateway controller, said calling terminal having said first multi-media capability associated therewith.

13. The method of claim 12, wherein said step of sending said call setup message from said first node further comprises the step of:
receiving, at said first node, said call setup message including said attribute from said calling terminal.

14. The method of claim 12, wherein said step of sending said call setup message from said first node further comprises the steps of:
receiving, at said first node, said call setup message from said calling terminal; and
adding said attribute to said call setup message.

15. The method of claim 12, wherein said step of receiving said response message further comprises the step of:
sending said response message from a second node serving a called terminal within a second network to said media gateway controller, said called terminal having said second multi-media capability associated therewith.

16. The method of claim 15, wherein said first and second networks utilize different call control protocols.

17. The method of claim 16, wherein said step of receiving said response message further comprises the steps of:
sending said call setup message including said attribute from said media gateway controller to said second node;
determining said second multi-media capability associated with said called terminal; and
determining whether interworking between said first and second multi-media capabilities is needed and whether said second node can perform said interworking.

18. The method of claim 17, wherein said step of receiving said response message further comprises the step of:
sending said response message to said media gateway controller in response to a determination that interworking between said first and second multi-media capabilities is needed and that said second node cannot perform said interworking.

19. The method of claim 16, wherein said call setup message further includes a B-number associated with a third network.

20. The method of claim 19, wherein said step of receiving said response message further comprises the steps of:
sending said call setup message including said attribute and said B-number from said media gateway controller to a third node within said third network;
determining a C-number associated with said called terminal; and
forwarding said call setup message including said attribute to said second node within said second network.
